(19) United States
(12) Patent Application Publication
(10) Pub. No.: US 2003/0152720 A1
(43) Pub. Date: Aug. 14, 2003

(54) Ink jet recording sheet, method for the preparation of same, and ink jet recording method using same

(76) Inventor: Michael Lubar, Miamisburg, OH (US)

Correspondence Address: CANTOR COLBURN LLP, 55 Griffin Road South, Bloomfield, CT, 06002, US

(21) Appl. No.: 10/233,129

(22) Filed: Aug. 30, 2002

Related U.S. Application Data
(60) Provisional application No. 60/355,107, filed on Feb. 8, 2002.

(51) Int. Cl. B41M 5/00

(52) U.S. Cl. 428/32.25; 428/32.18; 428/32.19; 428/32.33; 428/32.37

(57) ABSTRACT

An ink jet recording sheet includes a substrate, an ink receiving layer, and a clay-containing layer between the paper substrate and the ink receiving layer. The clay-containing layer contains platelet clay particles having an average aspect ratio of at least 10:1, and an orientation such that at least 50% of the platelet clay particles have a major axis within 30° of parallel to the substrate. The sheet exhibits little or no cockle formation, even at high ink laydowns. A method of preparing the ink jet recording sheet and a method of printing using the ink jet recording sheet are also described.

### CROSS REFERENCE TO RELATED APPLICATIONS

This application claims the benefit of U.S. Provisional Application Serial No. 60/355,107 filed Feb. 8, 2002.

### BACKGROUND

Reproduction of images by ink jet printing typically requires high ink laydowns of about 1.5 to about 2.3 milliliters per square-meter. When the receiving material contains a water-absorbing substrate, such as paper, that is readily accessible to the ink, these high fluid loads can results in a distortion of the receiver known as cockle. This is particularly a problem for wide format printers, where fluid laydowns may be higher than those encountered with desktop printers. Cockle formation may cause direct contact of the printhead with the receiver, which may damage the receiver and result in loss of the work piece. In extreme cases, contact of the printhead with the receiver may damage the printhead.

Several approaches have been devised to reduce cockle in ink jet receivers with water-absorbing substrates. In one approach, a so-called RC paper (resin-coated paper) is prepared by extrusion coating a paper substrate on both sides with a film of a hydrophobic resin such as polyethylene. An ink receiving layer is then applied on top of the hydrophobic resin layer. This approach effectively prevents cockle by blocking ink access to the paper substrate, but RC papers are very expensive to produce.

In another approach, a paper substrate may be coated with a dispersion of a hydrophobic polymer such as an ethylene-acrylic acid copolymer. Drying of this coating produces a hydrophobic layer, over which an ink receiving layer is coated. An example of such a receiver is described, for example, in U.S. Patent Application Publication No. 2002/0012774 A1 to Neithardt et al. Ink jet receivers of this type provide somewhat less cockle resistance than RC paper, but they are less expensive to produce. Even so, they are substantially more costly to produce than so-called plain paper because another coating operation is required, and there remains a desire for improved cockle resistance at reduced cost.

### BRIEF SUMMARY

The above-described and other drawbacks and disadvantages of the prior art are alleviated by an ink jet recording sheet, comprising: a substrate; an ink receiving layer; and a clay-containing layer, wherein the clay-containing layer is interposed between the paper substrate and the ink receiving layer, wherein the clay-containing layer comprises platelet clay particles, wherein the platelet clay particles have an average aspect ratio of at least 10:1, and wherein at least 50% of the platelet clay particles have a major axis within 30° of parallel to the substrate.

Other embodiments, including a method of preparing the ink jet recording sheet, and a method of recording an image using the ink jet recording sheet, are described in detail below.

### BRIEF DESCRIPTION OF THE DRAWINGS

Referring now to the drawings wherein like elements are numbered alike in several FIGURES:

FIG. 1 is a photomicrograph of a platelet-particle-containing clay.

FIG. 2 is a photomicrograph of a calcined clay.

FIG. 3 is cross section photomicrograph of an ink jet recording sheet, showing the ink receiving layer, the clay-containing layer, and the substrate.

FIG. 4 is a cross section photomicrograph of an ink jet recording sheet, showing the ink receiving layer, the clay-containing layer, and a portion of the substrate.

FIG. 5 is a cross section photomicrograph of an ink jet recording sheet, showing the ink receiving layer and a portion of the clay-containing layer.

FIG. 6 is a cross section photomicrograph of an ink jet recording sheet, showing the interface of the clay-containing layer and the substrate.

### DETAILED DESCRIPTION OF THE PREFERRED EMBODIMENTS

One embodiment is an ink jet recording sheet, comprising: a substrate; an ink receiving layer; and a clay-containing layer, wherein the clay-containing layer is interposed between the paper substrate and the ink receiving layer, wherein the clay-containing layer comprises platelet clay particles, wherein the platelet clay particles have an average aspect ratio of at least 10:1, and wherein at least 50% of the platelet clay particles have a major axis within 30° of parallel to the substrate.

The ink jet recording sheet comprises a substrate. While there is no particular limitation on the composition or physical properties of the substrate, the advantages of the invention are most evident when the substrate is water-absorbing. In particular, the substrate may preferably be capable of absorbing at least 50%, preferably at least 70%, more preferably at least 90%, of its own weight in water at room temperature.

In a preferred embodiment, the substrate is opaque.

In a highly preferred embodiment, the substrate comprises paper. Preferred pulps used for making paper substrates include hardwood pulps such as, for example, oak, maple, poplar, birch, chestnut, aspen, beech, eucalyptus, walnut, and the like, and mixtures comprising at least one of the foregoing hardwood pulps.

A preferred ink receiving layer may comprise, before coating, about 30 to about 50 parts by weight of water, about 2 to about 10 parts by weight of isopropanol, about 20 to about 60 parts by weight of polyvinylpyrrolidone, about 10 to about 50 parts by weight of a partially cross-linked polyvinylpyrrolidone, about 0.1 to about 3 parts by weight of a fluorescent brightener, about 0.01 to about 1 part by weight of a nonionic surfactant. Optionally about 0.1 to about 10 weight percent of a cationic dye fixative may be employed, based on the total weight of the composition before coating. An example of a dye fixative is a poly(diallyl dimethyl ammonium chloride) (DADMAC) having a number average molecular weight of at least about 500,000 atomic mass units. In one embodiment, the ink receiving layer may comprise about 0.1 to about 5 weight percent of a hydrolyzed poly(vinyl acetate). A suitable hydrolyzed poly(vinyl acetate) is commercially available as, for example, Celvol 325 from Celanese Chemicals. In another embodiment, the ink receiving layer may be internally reinforced by further comprising about 0.1 to about 5 weight percent of a styrene butadiene in the form of a latex. A suitable styrene butadiene latex is commercially available as, for example, Dow 620 from Dow Chemical.

In one embodiment, the ink receiving layer is coated at a dry weight basis of up to about 14 g/m², preferably up to about 12 g/m², more preferably up to about 10 g/m².

In a preferred embodiment, the ink receiving layer is substantially free of inorganic fillers. By substantially free of inorganic fillers, it is meant that the ink receiving layer contains less than 1% by dry weight of intentionally added inorganic fillers. Such inorganic fillers include, for example, clay, activated clay, talc, calcium carbonate, calcium sulfate, calcium silicate, diatomaceous earth, magnesium silicate, terra abla, magnesium oxide, magnesium carbonate, aluminum hydroxide, and the like.

The ink jet recording sheet comprises a clay-containing layer interposed between the paper substrate and the ink receiving layer. The clay-containing layer comprises platelet clay particles having a number average aspect ratio of at least 10:1, preferably at least about 15:1, more preferably at least about 18:1.

In a preferred embodiment, the platelet clay particles in the clay-containing layer may have a diameter of about 0.1 to about 5 micrometers. Within this range, the platelet clay particles may preferably have a diameter of at least about 0.3 micrometer, more preferably at least about 0.5 micrometers, still more preferably at least about 1 micrometer. Also within this range, the platelet clay particles may preferably have a diameter of up to about 3 micrometers, more preferably up to about 2 micrometers.

The diameter, thickness, and aspect ratio may be conveniently determined by analyzing a cross-section of the sheet by optical microscopy. A majority of the platelet clay particles in the clay-containing layer also are oriented substantially parallel to the substrate. Specifically, at least about 50%, preferably at least about 70%, more preferably at least about 90% of the platelet clay particles may have a diameter within about 30°, preferably within about 20°, more preferably within about 10°, of parallel to the plane of the paper substrate.

The clay is preferably provided in the form of an aqueous slurry, which may, optionally, include other components such as dispersants. The clay is preferably not a so-called calcined clay. Calcined clays typically exhibit insufficient diameters and aspect ratios.

The clay-containing layer may comprise about 5 to about 30 g/m² of clay, on a dry weight basis. Within this range, it may be preferred to use at least about 7 g/m², more preferably at least about 9 g/m², of clay. Also within this range, it may be preferred to use up to about 20 g/m², more preferably up to about 15 g/m², of clay.

The clay amount may also be expressed as a dry weight fraction of the clay-containing layer. In this case, the clay amount may be about 20 to about 90 weight percent, based on the total dry weight of the clay-containing layer. Within this range, it may be preferred to use at least about 40 weight percent, more preferably at least about 50 weight percent, of clay. Also within this range, it may be preferred to use up to about 80 weight percent, more preferably up to about 75 weight percent, of clay.

Suitable clays having platelet clay particles are known in the art and commercially available as, for example, COVERGLOSS® from J. M. Huber Corporation, having about 96-99 weight percent of particles smaller than 2 micrometers; HYDRAGLOSS® from J. M. Huber Corporation, having about 92-98 weight percent of particles smaller than 2 micrometers; HYDRAGLOSS® 92 from J. M. Huber Corporation, having about 98-100 weight percent of particles smaller than 2 micrometers; and HYDRAFINE® 90 from J. M. Huber Corporation, having about 90-96 weight percent of particles smaller than 2 micrometers. Such clays are generally obtained as slurries in water, where the platelet clay particles have diameters, thicknesses, and aspect ratios as described above for characterization of the platelet clay particles within the clay-containing layer of the recording sheet. Suitable clays are also available in dry form, but dry form may be more susceptible than slurries to losses in plate-like structure over time.

In addition to clay, the clay-containing layer may comprise a binder. Suitable binders include, for example, poly(vinylpyrrolidone-co-vinyl acetate), poly(vinyl alcohol), poly(vinyl acetate), cellulose ethers, poly(styrene-co-butadiene), poly(alkyl acrylate-co-styrene), polyurethane, and the like, and mixtures comprising at least one of the foregoing binders. The binder may be present at about 2 to about 30 weight percent, based on the total dry weight of the clay-containing layer. Within this range, it may be preferred to use a binder amount of at least about 4 weight percent, more preferably at least about 6 weight percent. Also within this range, it may be preferred to use a binder amount of up to about 20 weight percent, more preferably at least about 15 weight percent.

The clay-containing layer may, optionally, comprise other additives, including, for example, fluorescent brighteners, plastic pigment (spheres), anti-blocking pigments, waxes, and the like, and mixtures comprising at least one of the foregoing additives. When included, such additives may be used in amounts readily determined by those skilled in the art.

In a preferred embodiment, the ink jet recording sheet exhibits a 75° gloss value of at least about 70, more preferably at least about 80, yet more preferably at least about 90, measured according to ASTM D523.

In another preferred embodiment, the ink jet recording sheet at 23° C. may absorb a drop of 23° C. deionized water in about 60 to about 240 seconds. Within this range, the absorption time will preferably be at least about 100 seconds, more preferably at least about 120 seconds. Also within this range, the absorption time will preferably be up to about 200 seconds, more preferably up to about 160 seconds. It will be understood that a drop is defined as a volume of about 0.05 milliliters.

In another preferred embodiment, when a drop of 23° C. deionized water is placed on the ink jet recording sheet at 23° C., the sheet will remain cockle-free for at least about 240 seconds, preferably at least about 270 seconds, more preferably at least about 300 seconds.

Another embodiment is a method of preparing an ink jet recording sheet, comprising: coating a clay-containing layer on a substrate, wherein the clay-containing layer comprises platelet clay particles, wherein the platelet clay particles have an average aspect ratio of at least 10:1 and wherein at least 50% of the platelet clay particles have a major axis within 30° of parallel to the substrate; and coating an ink receiving layer on the clay-containing layer.

Yet another embodiment is a method of recording, comprising: applying droplets of a recording liquid onto an ink jet recording sheet, wherein the ink jet recording sheet comprises a substrate; an ink receiving layer; and a clay-containing layer, wherein the clay-containing layer is interposed between the paper substrate and the ink receiving layer, wherein the clay-containing layer comprises platelet clay particles, wherein the platelet clay particles have an average aspect ratio of at least 10:1, and wherein at least 50% of the platelet clay particles have a major axis within 30° of parallel to the substrate. While there is no restriction on the recording liquid used in the method, water-based inks (i.e., inks containing at least about 80% weight percent water based on the total weight of solvent) may be preferred.

The invention is further illustrated by the following non-limiting examples.

### EXAMPLE 1 COMPARATIVE EXAMPLE 1

This example provides electron micrographs of two clays, one representative of a clay containing platelet clay particles, and the other representative of a calcined clay. For Example 1, a clay containing platelet clay particles was obtained as HYDRAGLOSS® from J. M. Huber Corporation, having about 92-98 weight percent of particles smaller than 2 micrometers. Particle size analysis of the clay particles in this paper was conducted by mounting a dilute dispersion of the particles on a carbon film supported by a transmission electron microscopy (TEM) grid, and analyzing the sample with a JEOL JSM 6500 field emission scanning electron microscope using secondary electrons. The digitized images of the particles were transferred to an image analysis program and apparent particle thickness and X- and Y-caliper dimensions were obtained for each particle. The measurements were then corrected for the effect of sample tilt and the average diameter and aspect ratio was calculated. Analysis of 100 platelet clay particles yielded a mean thickness of 45 nanometers, a mean diameter of 634 nanometers, and a mean aspect ratio of 19.3 nanometers.

For Comparative Example 1, a calcined clay was obtained as HYCAL® from J. M. Huber Corporation, having about 86-96 weight percent of particles smaller than 2 micrometers. Particle size analysis of 99 calcined clay particles yielded a mean thickness of 480 nanometers, a mean diameter of 2524 nanometers, and a mean aspect ratio of 5.5.

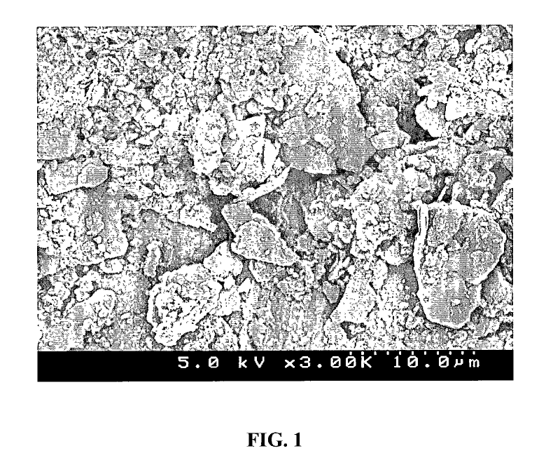

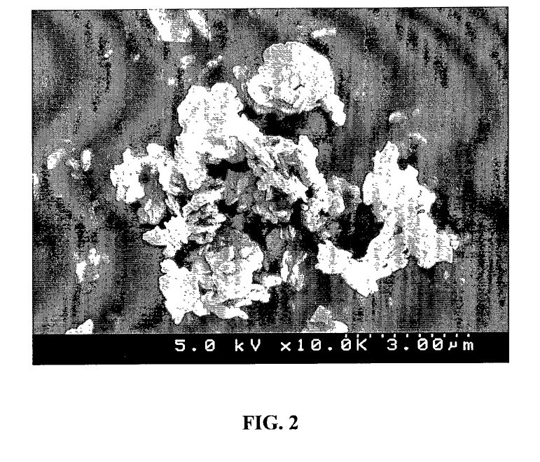

The two clays were analyzed by scanning electron microscopy, yielding the images shown as FIG. 1 (Example 1) and FIG. 2 (Comparative Example 2). The electron micrographs and the particle size analysis above show that the Example 1 clay includes more and larger platelet clay particles than the Comparative Example 1 clay.

### EXAMPLE 2 COMPARATIVE EXAMPLE 2

This example describes the preparation and testing of an ink jet recording sheet. For use in Example 2, a glossy, clay-coated (both sides) paper was obtained as IKONO® Gloss from Zanders USA, Inc. The paper is a super calendered cover stock, made with hard woods, is non-acid, and has a gloss of 80 at 75°. Analysis of the paper suggests that the clay layer is coated at about 15 g/m² (on a dry weight basis), with the coated layer having the approximate composition, with component amounts expressed in parts by weight (pbw): 50 pbw papermakers' #1 clay in slurry form, containing about 60% by weight dry clay, 35% water, and about 5% dispersants; 10 pbw 2-ethylhexyl acrylate/styrene copolymer; 1 pbw fluorescent brightener; and 35 pbw water (to adjust viscosity to less than 200 centipoise). Particle size analysis of the clay particles in this paper was conducted by ashing the paper in an oxygen plasma to remove paper fibers, treating the ash with dilute hydrochloric acid to remove the carbonate portion of the coating, and then following the procedure described for EXAMPLE 1. Analysis of 100 particles yielded a mean thickness of 96 nanometers, a mean diameter of 1209 nanometers, and a mean aspect ratio of 19.4.

For use in Comparative Example 2 a conventional clay-coated paper was obtained from Appleton as Gloss Utopia 60# Text Blue White, which is a calcined clay coated white stock having lower gloss than the IKONO® Gloss paper.

Over the clay-containing layer of each substrate was coated an ink receiving layer at a dry weight basis of 9.8 g/m². The ink receiving layer had the following composition:

43.0 pbw water

5.7 pbw isopropanol

30.4 pbw polyvinylpyrrolidone K-120, 12 weight % in water

1.1 pbw BLANKOPHOR® TX

0.1 pbw TRITON® X-100

20.0 pbw VIVIPRINT® 540

The polyvinylpyrrolidone PVP-K120 (Chemical Abstracts Registry No. 9003-39-8) was obtained from ISP and had a number average molecular weight of about 1,300,000 atomic mass units. The VIVIPRINT® 540 is a partially cross-linked polyvinylpyrrolidone in the form of water-swollen microparticles; it was obtained from ISP. The BLANKOPHOR® TX is a fluorescent brightener obtained from Bayer. TRITON® X-100 is (p-t-octylphenoxy)polyethoxyethanol surfactant (Chemical Abstracts Registry No. 9002-93-1) used here as a wetting agent; it was obtained from Union Carbide.

After coating of the ink receiving layer, each paper was dried, treated with a steam foil and calendered on both sides at 2,500 pounds per linear inch with a soft nip calender using room temperature rollers.

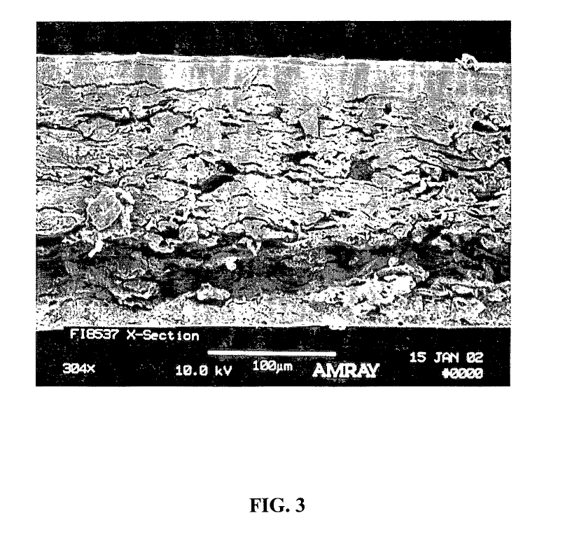

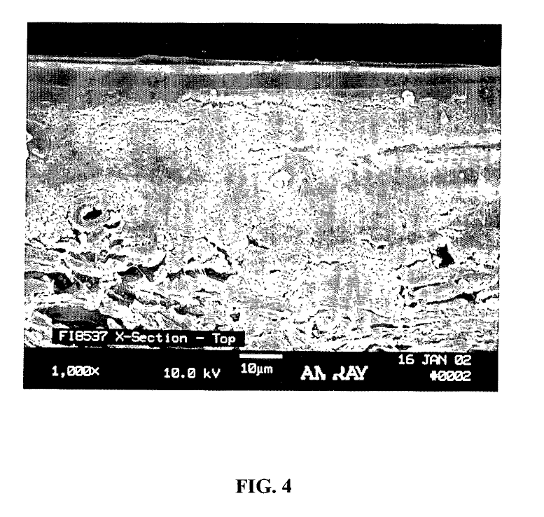

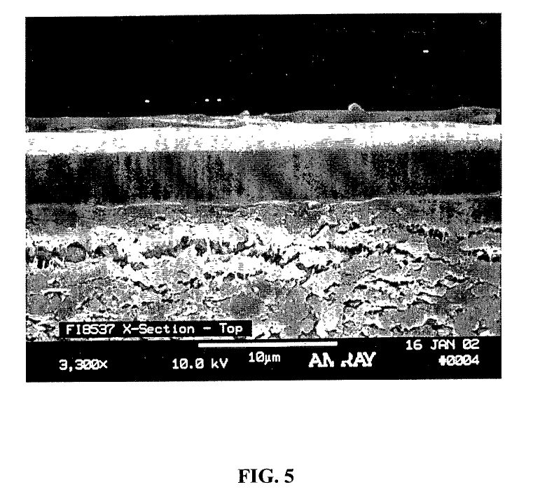

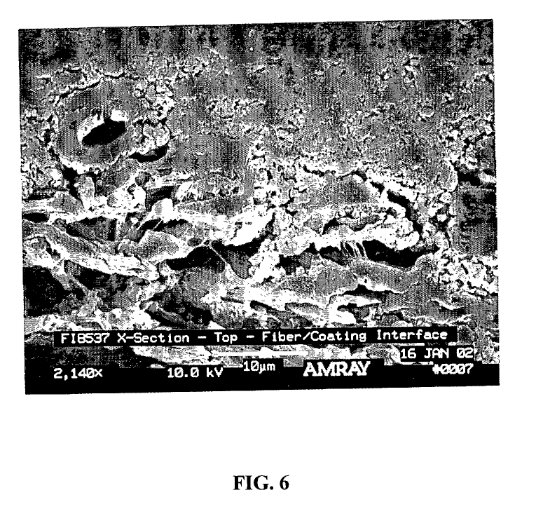

The ink jet recording sheet corresponding to Example 2 was analyzed in cross-section by scanning electron microscopy (SEM). Representative cross-section micrographs are shown in FIGS. 3-6. FIG. 3 is a full cross section of the sheet, showing (from top to bottom), the ink receiving layer, the clay-containing layer, and the substrate. FIG. 4 is a higher magnification view, showing the ink receiving layer, the clay-containing layer, and a portion of the substrate. FIG. 5 is an even higher magnification view, showing the ink receiving layer and a portion of the clay-containing layer. FIG. 7 is a high magnification view of the interface of the clay-containing layer and the substrate.

### COMPARATIVE EXAMPLE 3

A clay coating was prepared as in Example 2, substituting for the papermakers' #1 clay a calcined clay obtained as HYCAL® from J. M. Huber having 86-96 weight percent of particles less than 2 micrometers.

The ink receiving layer of Example 2 was applied, and the resulting paper was dried, steam foiled, and calendered as in Example 2. When a solid-color image requiring an ink laydown of 2.3 mL/m² was printed on the receiver using a Hewlett Packard HP5000 inkjet plotter, cockling occurred within the first three printing passes.

### EXAMPLE 3 COMPARATIVE EXAMPLES 4-6

An Encad plotter in general deposits more ink than a Hewlett Packard plotter of the same width. Therefore, an Encad 700 model was selected to perform a cockle test. An Encad demo RTL (raster transfer language) file containing sections of very heavy ink loading (about 2.5 to 3.0 g/m²) was chosen and the plotter set up in default mode. In the RTL mode the plotter will ignore all but the compiled file instructions so default mode is justified.

Four materials were compared. As a first control, a resin coated Photobase commercial material was used. As an inventive sample, the material of Example 2 was used. As a second control, a calcined clay coating prepared according to Comparative Example 3 was used. As a third control, a commercial heavy weight (150 g/m²) matte paper was used.

The same 3 inch by 36 inch section of each printed sample was visually examined for cockle and rated for the number of welts formed:

| | |
|---|---|
| Resin Coated Photo base | 0 |
| Delaminated Clay | 1 |
| Calcined Clay | 40 |
| Heavy weight matte | 7 |

These results show the delaminated clay of the inventive sample to be an effective barrier to ink water penetration on the printing timescale.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

All cited patents, patent applications, and other references are incorporated herein by reference in their entirety.

1. An ink jet recording sheet, comprising:
a substrate;
an ink receiving layer; and
a clay-containing layer, wherein the clay-containing layer is interposed between the paper substrate and the ink receiving layer, wherein the clay-containing layer comprises platelet clay particles, wherein the platelet clay particles have an average aspect ratio of at least 10:1, and wherein at least 50% of the platelet clay particles have a major axis within 30° of parallel to the substrate.

2. The ink jet recording sheet of claim 1, wherein the substrate is opaque.

3. The ink jet recording sheet of claim 1, wherein the substrate is capable of absorbing at least 50% of its own weight in water.

4. The ink jet recording sheet of claim 1, wherein the substrate is paper.

5. The ink jet recording sheet of claim 1, wherein the ink receiving layer has a dry weight up to about 14 g/m².

6. The ink jet recording sheet of claim 1, wherein the ink receiving layer is substantially free of inorganic filler particles.

7. The ink jet recording sheet of claim 1, wherein the ink receiving layer comprises, before coating, about 30 to about 50 parts by weight of water, about 2 to about 10 parts by weight of isopropanol, about 20 to about 40 parts by weight of polyvinylpyrrolidone, about 10 to about 30 parts by weight of a partially cross-linked polyvinylpyrrolidone, about 0.1 to about 3 parts by weight of a fluorescent brightener, about 0.01 to about 1 part by weight of a nonionic surfactant.

8. The ink jet recording sheet of claim 1, wherein the platelet clay particles have an average aspect ratio of at least 15:1.

9. The ink jet recording sheet of claim 1, wherein at least 70% of the platelet clay particles have a diameter within 30° of parallel to the paper substrate.

10. The ink jet recording sheet of claim 1, wherein the platelet clay particles are provided as an aqueous slurry.

11. The ink jet recording sheet of claim 1, wherein the clay-containing layer comprises about 5 to about 30 g/m² of clay, on a dry weight basis.

12. The ink jet recording sheet of claim 1, wherein the clay-containing layer comprises about 20 to about 90 weight percent clay, on a dry weight basis.

13. The ink jet recording sheet of claim 1, wherein the sheet exhibits a 75° gloss value of at least about 70 measured according to ASTM D523

14. The ink jet recording sheet of claim 1, wherein a drop of deionized water place on the sheet is absorbed in about 60 to about 240 seconds.

15. The ink jet recording sheet of claim 1, wherein a drop of deionized water place on the sheet does not produce cockle within 240 seconds.

16. An ink jet recording sheet, consisting of:
a substrate;
an ink receiving layer; and
a clay-containing layer, wherein the clay-containing layer is interposed between the paper substrate and the ink receiving layer, wherein the clay-containing layer comprises platelet clay particles, wherein the platelet clay particles have an average aspect ratio of at least 10:1, and wherein at least 50% of the platelet clay particles have a major axis within 30° of parallel to the substrate.

17. A method of preparing an ink jet recording sheet, comprising:
coating a clay-containing layer on a substrate, wherein the clay-containing layer comprises platelet clay particles, wherein the platelet clay particles have an average aspect ratio of at least 10:1, and wherein at least 50% of the platelet clay particles have a major axis within 30° of parallel to the substrate; and
coating an ink receiving layer on the clay-containing layer.

18. A method of recording, comprising:
applying droplets of a recording liquid onto an ink jet recording sheet, wherein the ink jet recording sheet comprises a substrate; an ink receiving layer; and a clay-containing layer, wherein the clay-containing layer is interposed between the paper substrate and the ink receiving layer, wherein the clay-containing layer comprises platelet clay particles, wherein the platelet clay particles have an average aspect ratio of at least 10:1, and wherein at least 50% of the platelet clay particles have a major axis within 30° of parallel to the substrate.
